(19) United States
(12) Patent Application Publication
(10) Pub. No.: US 2023/0281511 A1
(43) Pub. Date: Sep. 7, 2023

(54) DEVICE AND METHOD FOR DETERMINING SAFE ACTIONS TO BE EXECUTED BY A TECHNICAL SYSTEM

(71) Applicant: Robert Bosch GmbH, Stuttgart (DE)

(72) Inventors: Philipp Geiger, Karlsruhe (DE); Christoph-Nikolas Straehle, Weil Der Stadt (DE)

(21) Appl. No.: 18/164,359

(22) Filed: Feb. 3, 2023

(30) Foreign Application Priority Data
Mar. 3, 2022 (EP) 22 15 9967.3

(51) Int. Cl. G06N 20/00

(52) U.S. Cl. CPC G06N 20/00

(57) ABSTRACT

A computer-implemented method for training a machine learning system. The machine learning system is configured to determine a control signal characterizing an action to be executed by a technical system. The method includes obtaining a safe action to be executed by the technical system including: obtaining a state signal; determining, by a parametrized policy module of the machine learning system, a distribution of potentially unsafe actions that could be executed by the technical system; sampling a potentially unsafe action from the distribution; obtaining, by a safety module of the machine learning system, the safe action. The method further includes determining a loss value based on the state signal and the safe action; and training the machine learning system by updating parameters of the policy module according to a gradient of the loss value with respect to the parameters.

### CROSS REFERENCE

The present application claims the benefit under 35 U.S.C. § 119 of European Patent Application No. EP 22 15 9967.3 filed on Mar. 3, 2022, which is expressly incorporated herein by reference in its entirety.

### FIELD

The present invention relates to a computer-implemented method for training a control system, a training system, a control system, a computer program, and a machine-readable storage medium.

### BACKGROUND INFORMATION

Bhattacharyya et al. 2020 “Modeling Human Driving Behavior through Generative Adversarial Imitation Learning”, https://arxiv.org/abs/2006.06412v1 describes the use of generative adversarial imitation learning for learning-based driver modeling.

Modern technical devices often-times interact with their environment by executing certain actions. For example, a robot arm may move from one point to another wherein the movement may constitute an action. An at least partially automated vehicle may execute a longitudinal and/or lateral acceleration, e.g., by steering and/or acceleration of the wheels. A manufacturing robot may further execute actions specific to a tool mounted to the robot, e.g., gripping, cutting, welding, or soldering.

An action to be executed by a technical system is typically determined by a control system. In most modern system, actions may be formulated abstractly by the control system, wherein further components of the technical system may then translate the abstract action into actuator commands such that the action is executed. For example, the control system of the manufacturing robot from above may determine to execute the action “gripping” and submit a control signal characterizing the action “gripping” to another component, wherein the other component translates the abstract action into, e.g., electric currents for a pump of a hydraulic of the robot or a motor, e.g., a servo motor, for controlling a gripper of the robot.

In general, an action executed by a robot may be considered safe with respect to some desired safety goal and/or desired behavior. An autonomous vehicle may, for example, be considered as performing safe actions if an action determined by the control system does not lead to a collision of the vehicle with other road participants and/or environmental entities.

Determining safe actions for a technical system is typically a non-trivial problem. This is in parts due to the fact that safe actions (e.g., stop in the emergency lane) may not always contribute to a desired behavior of the technical system (e.g., travel to a desired destination) and may in fact even be detrimental to achieving the desired behavior.

Hence, it is desirable to obtain a control system for a technical system that is able to determine actions to be executed by the technical system, wherein the actions are safe with respect to one or multiple safety goals and wherein the actions further contribute to achieving a desired behavior.

Advantageously, a method according to the present invention allows for determining a machine learning system that is configured to provide a control signal characterizing safe actions to be performed by a technical system. In addition to being safe, the actions determined by the machine learning system advantageously allow for achieving a desired behavior in addition to being safe as long as the desired behavior is safe.

### SUMMARY

In a first aspect, the present invention concerns a computer-implemented method for training a machine learning system, wherein the machine learning system is configured to determine a control signal characterizing an action to be executed by a technical system. According to an example embodiment of the present invention, the method for training comprises the following steps:
Obtaining a safe action to be executed by the technical system, wherein obtaining the safe action comprises the steps of:
   Obtaining a state signal, wherein the state signal characterizes a state of the environment;
   Determining, by a parametrized policy module of the machine learning system, a distribution of potentially unsafe actions that could be executed by the technical system, wherein the policy module determines the distribution based on the obtained state signal;
   Sampling a potentially unsafe action from the distribution;
   Obtaining, by a safety module of the machine learning system, the safe action, wherein the safe action is obtained based on the sampled potentially unsafe action and a set of safe actions with respect to a current environment of the technical system;
Determining a loss value based on the state signal and the safe action, wherein the loss value characterizes a reward obtained based on the safe action;
Training the machine learning system by updating parameters of the policy module according to a gradient of the loss value with respect to the parameters.

The machine learning system trained with the method may be understood as a part of a control system for controlling a technical system such as a robot, e.g., an at least partially automated vehicle, a drone, other autonomous agents, or a manufacturing machine. The control signal may characterize a high-level action to be performed (e.g., perform a lane change, grip a workpiece), wherein the control signal may then be processed further such that an actuator of the technical system is controlled such that the technical system performs the action characterized by the control signal.

The training method may be understood as advantageously being applicable for reinforcement learning. For example, the loss value may characterize a log likelihood of the distribution of potentially unsafe actions and training may be conducted using common reinforcement learning strategies, e.g., vanilla policy gradients, trust region policy optimization, or proximal policy optimization, wherein the machine learning system characterizes a parametrized policy and the loss value a main ingredient for policy optimization.

According to an example embodiment of the present invention, preferably, the method may be used within a framework for generative adversarial imitation learning, wherein the machine learning system may again serve as parametrized policy. For example, the loss value may be determined by a discriminator and training the machine learning system may comprises training the policy module and the discriminator according to generative adversarial imitation learning. The loss value in this case may hence be understood as a reward obtained for fooling the discriminator.

Advantageously, according to an example embodiment of the present invention, the machine learning system comprises a safety module, which the inventors designed such that the machine learning system can be guaranteed to provide safe actions with respect to an environment of the technical system.

Internally, the machine learning system may be understood as first providing an action which may or may not be safe, hence a potentially unsafe action. This action may then be processed by the safety module and is transformed into a safe action if the safety module does not deem the potentially unsafe action to be safe with respect to a provided set of safe actions.

The actions determined from the machine learning system may especially be continuous actions. The output of the machine learning system may hence be a real-valued scalar or real-valued vector.

The machine learning system is provided an observation of the environment of the technical system as input in form of the state signal. The state signal may characterize the environment by providing measurements of certain aspects of the environment such as position of mobile or immobile entities, physical properties of the environment or entities of the environment (e.g., velocity, acceleration, temperature, or pressure). The state signal may especially be a real-valued scalar or a real-valued vector. For example, the technical system could sense the environment by means of an optical sensor (e.g., a lidar sensor, a camera, an ultrasonic sensor, or a thermal camera) providing an image and the image could be processed by another machine learning system, e.g., a convolutional neural network or a transformer, in order to determine a feature vector characterizing the image and thereby the environment. The feature vector could then be provided as state signal to the machine learning system. Alternatively, it is also possible that the state signal characterizes semantic information, e.g., distance to other elements of the environment such as humans, other robots, immobile structures, desired paths of the robot, or curvature of ways to travel along such as streets.

According to an example embodiment of the present invention, the machine learning system comprises the policy module for determining potentially unsafe actions based on the state signal. The policy module may be understood as being configured to determine the potentially unsafe action based on the state signal. The policy module preferably may be or may comprise a conditional normalizing flow, wherein the policy module determines an action by sampling from the conditional normalizing flow using the state signal as conditioning input. Alternatively, it is also possible to use a gaussian model, e.g., a conditional gaussian mixture model, as policy module.

This potentially unsafe action is then processed by the safety module. Preferably, if the potentially unsafe action is deemed safe with respect to the provided set of safe actions, the potentially unsafe action may be provided as safe action from the safety module. Otherwise, the potentially unsafe action may be mapped to a safe action.

Advantageously, according to an example embodiment of the present invention, integrating the safety module at training time into the machine learning model allows for training the policy module to provide actions that can be turned into safe actions by the safety module all the while training the machine learning system to provide safe actions for achieving a maximum reward characterized by the loss function. Using a concrete example, while the action “park in the emergency lane” may always be chosen as safe action by an at least partially automated vehicle, the action may not achieve a desired goal of the vehicle travelling to a desired destination. Integrating the safety layer as proposed by the inventors allows for accounting for both goals.

Preferably, according to an example embodiment of the present invention, obtaining the safe action by the safety module comprises mapping the potentially unsafe action to an action from the set of safe actions if the potentially unsafe action is not in the set of safe actions, wherein the mapping is performed by means of a piecewise diffeomorphism. In general, a function g:A→Ā may be understood as a piecewise differentiable injection (diffeomorphism) if there exists a countable partition (Aₖ)ₖ of the domain of g and differentiable (on the interiors) injections gₖ:Aₖ→Ā such that g|_{A}_{ₖ}=gₖ.

Advantageously, according to an example embodiment of the present invention, having the safety module perform the mapping by means of a piecewise diffeomorphism allows for computing exact densities for the safe action based on a density provided for the potentially unsafe action and vice versa. In turn, being able to determine an exact mapping from the density for the safe action and the density of the potentially unsafe action allows for determining the gradient of the loss function with respect to the parameters of the policy without discontinuities or approximations. The inventors found that this allows for an improved performance of the machine learning system after training while determining only safe actions, wherein performance may be understood as the ability of the machine learning system's provided actions to gather a desired reward in terms of reinforcement learning or imitation learning.

Preferably, according to an example embodiment of the present invention, mapping the potentially unsafe action to an action from the set of safe actions comprises
Determining a countable partition of the space of actions;
Determining, for each set of the countable partition, whether the set is safe set or an unsafe set, wherein a set is determined as safe set if the set only comprises actions from the set of safe actions and if there exists a trajectory of actions for future states that comprises only safe actions and wherein a set is determined as unsafe set otherwise;
If the potentially unsafe action is in an unsafe set:
   Determining a safe set from the partition based on the distribution of the potentially unsafe actions;
   mapping the potentially unsafe action to an action from the safe set;
   Providing the action as safe action;
Otherwise, providing the potentially unsafe action as safe action.

In other words, the space of actions (e.g., [symbol] for scalars and [symbol] for vectors) may be partitioned into countable sets, wherein the piecewise diffeomorphism may then act on the sets of the partition. This allows for determining the exact density of the safe action according to the change of variables formula:

$${p}_{\overline{a}} ( \overline{a} ) = {\sum }_{k : \overline{a} ∈ {g}_{k} ( {A}_{k} )} \vert det ( {J}_{{g}_{k}^{- 1}} ( \hat{a} ) \vert {p}_{\hat{a}} ( {g}_{k}^{- 1} ( \overline{a} ) ) ,$$

wherein gₖ is the piecewise diffeomorphism, â is the potentially unsafe action, ā is the safe action, J is the Jacobian, p_{â} is a probability density function for the potentially unsafe action and p_{ā} is a probability density function for the safe action.

Preferably, the partition elements may be hypercubes in the action space. For example, for a two-dimensional action space the partition elements may be non-overlapping rectangles, e.g., squares. The hypercubes may in general also only span a subspace of the action space, e.g., if for a continuous action space only a subset of actions is relevant for controlling the technical system.

Given the partition elements (i.e., sets of the partition) and the set of safe actions, it is then possible to determine for each partition element, whether the respective partition element comprises only safe actions. If so, the partition element may be considered as safe, wherein if it does not only contain safe actions it may be considered unsafe. This way, the action space may be divided in safe regions (indicated by the safe partition elements) and unsafe regions (indicated by the unsafe partition elements).

sĀₜ^{s}={a∈A:existsπ_{t+1:T},s·t·for allϕ_{t:T},t<t′≤T,d(sₜ′)≤0holds when starting from(s,a)att},

In addition, a partition element may preferably be marked as safe only if each action allows for a trajectory of safe action. In other words, the additional requirement may indicate that for an action to be considered safe, the action has to allow for future actions (i.e., the actions along the trajectory) that are also safe and not lead to a situation, where there is no more safe action can be determined by the machine learning system. The future actions may also consider actions from other agents (e.g., other road participants in case of an at least partially automated vehicle). Preferably, the set of safe actions for a state may hence be defined as:

sĀₜ^{s}={a∈A:existsπ_{t+1:T},s·t·for allϕ_{t:T},t<t′≤T,d(sₜ′)≤0holds when starting from(s,a)att},

sĀₜ^{s}={a∈A:existsπ_{t+1:T},s·t·for allϕ_{t:T},t<t′≤T,d(sₜ′)≤0holds when starting from(s,a)att},

wherein α is an action from the action space A, π_{t+1:T} is a future trajectory starting from timepoint t for a policy π, φ_{t:T} is a trajectory of other agents in the environment (policies of other agents if other agents are present in the environment), sₜ′ is the state at t′ under the dynamics implied by the above policies, and d is a function characterizing a safety cost. The safety cost may, for example, characterize potentially dangerous situations with a safety cost greater than zero (e.g., a state in which a collision of the technical system with elements of its environment is likely or unavoidable but has not yet happened may be assigned a safety cost greater than zero). Likewise, states that characterize a violation of a safety goal (e.g., collision with elements of the environment, unexpected maneuvers) may be assigned a safety cost greater than zero.

$${w}_{t} ( s , a ) = {min max max}_{{π}_{t + 1 : T} {Φ}_{t : T} {t}^{′} ∈ t + 1 : T} d ( {s}_{{t}^{′}} )$$

for all t. Preferably, according to an example embodiment of the present invention, one can determine for a given state whether there exists a future trajectory with safety cost less or equal to zero by an optimization characterized by the formula:

$${w}_{t} ( s , a ) = {min max max}_{{π}_{t + 1 : T} {Φ}_{t : T} {t}^{′} ∈ t + 1 : T} d ( {s}_{{t}^{′}} ) for all t .$$

wₜĀₜ^{s}={a:w_{t(s,a)}≤0}. From the definition of it follows that the set of safe actions can also be expressed as

wₜĀₜ^{s}={a:w_{t(s,a)}≤0}.

While in certain limited scenarios, it may be possible to compute the safe action set analytically, the inventors found that this may not be the case in general. Advantageously, the inventors found thar it is possible to circumvent the need for explicitly determining the whole set analytically, while nonetheless giving guarantees. This may be achieved, by checking wₜ(s,a) for a state s for just a finite sample of a's and then conclude on the value of wₜ(s,·) on neighborhoods of the sampled a's using Lipschitz continuity or extremality/convexity arguments. This way, an inner approximation Āₜ^{s} of the set of safe actions Āₜ^{s} may be obtained. An inner approximation may be understood as Ãₜ^{s} being a subset of Āₜ^{s}. The inner approximation may then be used as set of safe actions in the proposed method.

Alternatively, the inner approximation may be obtained based on knowing the safety cost of a finite set of corners or extremal points that span a partition element advantageously allows for assessing whether the entire partition element contains only safe actions.

According to an example embodiment of the present invention, a preferred way of determining the set of safe actions may hence be formulated by partitioning the space of actions into regular boxes (hyper-rectangles) (Aₖ)ₖ₌₁^{K} and then evaluating for each box Aₖ the worst case total safety cost wₜ(sₜ,a) by either an action a at the center of the respective box and then using the Lipschitz continuity argument to check if wₜ(sₜ, ·)≤0 for the full box Aₖ or by actions a at the corner of the box Aₖ and determining the box as safe iff wₜ(sₜ, ·)≤0 at all corners.

Preferably, according to an example embodiment of the present invention, the set of safe actions contains fail-safe actions that may be executed by the technical system in case no other safe action can be found. The fail-safe actions may comprise actions for bringing the technical system into a fail-safe state, e.g., by directing the technical system into a safe position (e.g., an emergency lane), performing an emergency maneuver (e.g., an emergency brake), or by powering of the technical system.

In other embodiments of the present invention, it is also possible that the steps of determining a safe set, mapping the potentially unsafe action to an action from the safe set, and providing the action as safe action may also be conducted even if the potentially unsafe action is already in a safe set, i.e., the steps are executed in any case. This may be due to preference in implementation of the proposed method. However, it is also possible that a safe action is considered even safer than the potentially unsafe action even if the potentially unsafe action resides in a safe set of the partition of the action space. A safer action could be understood, e.g., an action that allows for keeping an even bigger distance to other elements of the environment compared to another action.

Preferably, determining the safe set to map the potentially unsafe action into comprises determining, for each safe set in the partition, a probability density of a representative action of the respective safe set of the partition with respect to the distribution of potentially unsafe actions, wherein the safe set comprising the representative action with highest probability density value is provided as determined safe set.

A representative action may be understood as an action from a respective set of the partition, wherein the set is considered safe. The action may be considered representative in the sense that a probability density determined for the representative action may act as an approximation of the probability density of the set itself.

The representative action may, for example, be chosen such that the representative action lies at a center of a respective partition element. For example, considering a Euclidean space of actions, the representative action may be mean of the set.

Preferably, according to an example embodiment of the present invention, the representative action may also be chosen based on the potentially unsafe action. For example, a relative position of the potentially unsafe action in its unsafe set may be determined and the representative action for a safe set may then be chosen to be at the same relative position in the safe set as had the potentially unsafe action in the unsafe set.

It is also possible that multiple representative actions are used for determining the safe set to map the potentially unsafe action into. For example, multiple representative actions may be selected at predefined positions and/or positions including a relative position of the potentially unsafe action with respect to the unsafe set and an average probability density value of these representative actions may then be used for characterizing a probability density of the respective safe sets.

Advantageously, this allows for mapping the potentially unsafe action to an action that is still considered feasible by the policy module while allowing for staying safe. This may be understood as finding a best compromise between an action considered to be the best by the policy module to achieve a desired goal (e.g., maximum reward, maximum imitation accuracy) while performing only safe actions.

Alternatively, it is also possible that determining the safe set comprises determining, for each safe set in the partition, a probability density of a representative action of the respective safe set of the partition with respect to the distribution of potentially unsafe actions, wherein a safe set is sampled based on the determined probability densities and the sampled safe set is provided as determined safe set.

This embodiment of the present invention may be understood as determining a mixture model over the space of safe actions and then sampling from the mixture model. Advantageously, this allows the method to also explore actions that may not be associated with the highest density with respect to the distribution of potentially unsafe actions. The inventors found that this exploration characteristic allows for overcoming local minima during training and hence for an increased performance of the machine learning system after training.

Alternatively, the safe set may also be determined by choosing the set from the partition that is deemed safe and has a minimal distance to the potentially unsafe action.

A distance from a partition element may be understood as a minimal distance of any action the partition element to the potentially unsafe action. Choosing the partition element with minimal distance to the action likewise allows for obtaining a good compromise between an action considered to be the best by the policy module to achieve maximum and staying safe.

Having determined a safe set to map into, mapping the potentially unsafe action to an action from the safe set and providing the action as safe action may preferably comprise determining a relative position of the potentially unsafe action in the unsafe set and providing the action at the relative position in the safe set as safe action.

In other words, the relative position of the potentially unsafe action in its original partition element may be determined and the safe action may then be chosen according to this relative distance, e.g., by choosing the action in the determined safe set that is at the same relative position in the safe set as was the potentially unsafe action in the unsafe set.

Alternatively, it is also possible that mapping the potentially unsafe action to an action from the safe set and providing the action as safe action comprises determining an action from the safe set that has a minimal distance to the potentially unsafe action and providing the action as safe action.

Preferably, the policy module is or comprises a conditional normalizing flow, wherein the potentially unsafe action is determined by sampling from the conditional normalizing flow conditional on the state signal.

Alternatively, the policy module may be or may comprises a conditional mixture model, wherein the potentially unsafe action is determined by sampling from the conditional model mixture model conditional on the state signal.

In another aspect, the present invention concerns a machine learning system configured according to any one of the embodiments described before. In particular, the machine learning system may comprise a policy module and a safety module as described above according to the present invention.

Ab advantage of the machine learning system is that the safety module may be trained in combination with the policy module (as described above). This advantageously allows for the machine learning system to achieve a better performance with respect to determining actions to be executed by the technical system.

In a further aspect, the present invention concerns a computer-implemented method for determining a control signal for controlling an actuator of a technical system. According to an example embodiment of the present invention, the method comprises the steps of:
Training a machine learning system using the method for training as proposed above;
Determining the control signal by means of the trained machined learning system and based on a state signal of an environment.

This may be understood as first training the machine learning system and then performing inference on the machine learning system. During inference, a potentially unsafe action may be mapped to a safe action as can be done during training (e.g., as presented above).

In a further aspect, the present invention concerns a computer-implemented method for training a machine learning system as described above, wherein the policy module is trained according to a reinforcement learning paradigm or an imitation learning paradigm and wherein during inference of the machine learning system potentially unsafe actions provided by the policy module are mapped to safe actions according to the step of obtaining, by the safety module of the machine learning system, the safe action as described above.

In other words, the safety module comprised by the machine learning system may only be used during inference. That is, the policy module may be trained individually (e.g., using a reinforcement learning algorithm such as policy gradients or an imitation learning algorithm such as generative adversarial imitation learning) and the safety module may be “tacked on” during inference. In general, for inferring a safe action from the safety module based on a potentially unsafe action the same steps may be used as were used during training. That is, the steps for mapping from a potentially unsafe action to a safe action disclosed in the aforementioned and the following embodiments are applicable during inference as well.

Embodiments of the present invention will be discussed with reference to the following figures in more detail.

### BRIEF DESCRIPTION OF THE DRAWINGS

FIG. 1 shows a machine learning system, according to an example embodiment of the present invention.

FIG. 2 shows a diagram depicting steps of a method for training the machine learning system, according to an example embodiment of the present invention.

FIG. 3 exemplarily a mapping of a potentially unsafe action to a safe action, according to an example embodiment of the present invention.

FIG. 4 shows a control system comprising a machine learning system controlling an actuator in its environment, according to an example embodiment of the present invention.

FIG. 5 shows the control system controlling an at least partially autonomous robot, according to an example embodiment of the present invention.

FIG. 6 shows the control system controlling a manufacturing machine, according to an example embodiment of the present invention.

FIG. 7 shows a training system for training the machine learning system, according to an example embodiment of the present invention.

### DETAILED DESCRIPTION OF EXAMPLE EMBODIMENTS

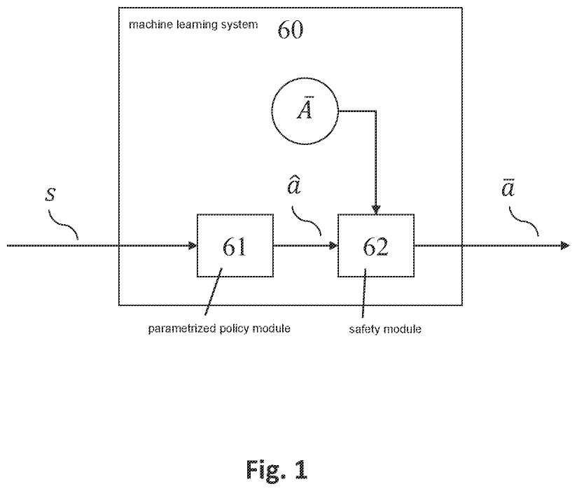

FIG. 1 shows a machine learning system (60) for determining a safe action (ā), wherein the safe action (ā) is used for controlling a technical system. The machine learning system (60) determines the safe action (ā) based on a state signal (s) provided to the machine learning system (60). The state signal (s) is processed by a parametrized policy module (61) of the machine learning system, wherein the policy module (61) is configured to provide a probability distribution for an action to be performed by the technical system. The policy module (61) may preferably comprise or be a conditional generative model using the state signal (s) as condition. Preferably, the generative model may be a conditional normalizing flow or a conditional gaussian model, e.g., a conditional gaussian mixture model.

A potentially unsafe action (â) may then be sampled from the policy module (61), wherein the potentially unsafe action (â) is then processed by a safety module (62) of the machine learning system (60). The safety module (62) is configured to map the potentially unsafe action (â) to the safe action (ā) if the safety module (62) deems the potentially unsafe action (â) to actually be unsafe. The safety module (62) determines the safety of the potentially unsafe action (â) based on a provided set of safe actions (Ā) that may be safely executed by the technical system in the environment. If the potentially unsafe action (â) is determined to be unsafe, the safety module (62) performs a mapping by means of a piecewise diffeomorphism from the unsafe action (â) to the safe action (ā). The determined safe action (ā) is then put out by the machine learning system (60).

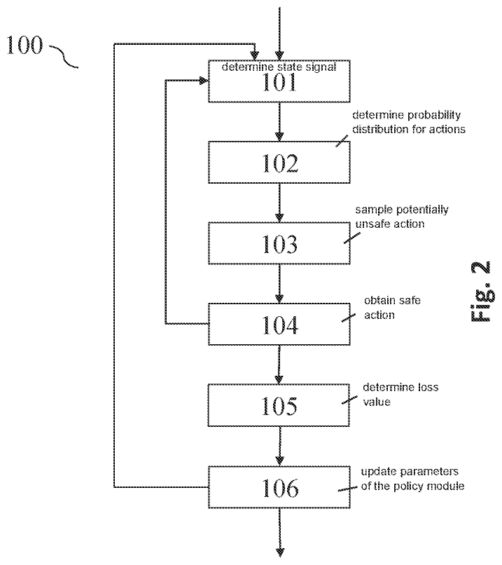

FIG. 2 shows a flow chart of a method (100) for training the machine learning system (60). The method starts with a first step (101), wherein in the first step (101) a state signal (s) is determined from the environment of the technical system.

In a second step (102), the policy module (61) of the machine learning system (60) then determines the probability distribution for actions from the preferably continuous action space.

In a third step (103) a potentially unsafe action (â) is sampled from the probability distribution.

In a fourth step (104), the safety module (62) of the machine learning system (60) obtains a safe action (ā) based on the potentially unsafe action (â) by means of the diffeomorphism.

The steps one (101) to four (104) may preferably be repeated in order to determine a trajectory of state signals (s) and safe actions (ā). The trajectory may then be used in a fifth step (105) of the method (100) for determining a loss value with respect to the actions. The loss value may preferably characterize a desired goal to be achieved. For example, the loss value may characterize an expected return. Preferably, the loss value is determined according to the framework of generative adversarial imitation learning, i.e., by comparing the determined trajectory to trajectories determined by an expert, wherein the comparison is performed based on a discriminator.

In a sixth step (106), parameters of the policy module (61) are then updated. Preferably, this is achieved by means of gradient descent, wherein a gradient of the loss value with respect to parameters of the policy module (61) is determined.

Preferably, the steps one (101) to six (106) are repeated iteratively until a desired amount of iterations is achieved and/or until the loss value or a loss value with respect to a validation set is equal to or below a predefined threshold. If one of the described exit criteria is met, the method (100) ends.

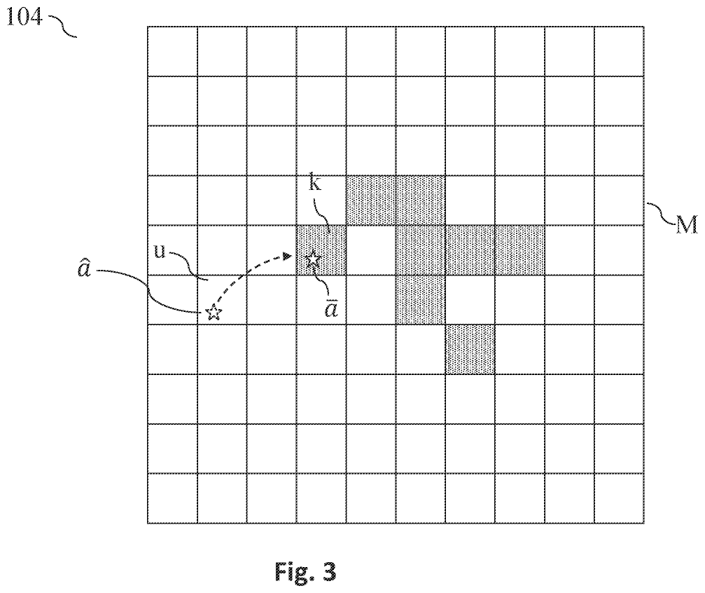

FIG. 3 depicts the fourth step (104) of the method (100) for training in more detail. The action space is partitioned into a partition (M), wherein the partition elements are boxes. The figure depicts an embodiment of a 2-dimensional action space. Preferably, the boxes are chosen to be squares, wherein an edge length of a box may be considered a hyperparameter of the method (100). It should be noted that the partition does not need to span the entire possible action space. For example, it is also possible that prior information allows for partitioning only a subspace of the action space.

In general, the shape of a box (e.g., geometric figure, length of sides, number of points in a polygon defining partition elements) may be considered a hyperparameter of the method (100). The partition elements, i.e., the different subsets of the action space may then be categorized as either safe sets (k) (indicated by shaded squares in the figure) and unsafe sets (u) (indicated by white squares in the figure). Determining whether a partition element (i.e., subset of the action space) is safe or not may be achieved by means of determining a worst-case safety cost wₜ(sₜ,a) as described earlier. For example, an action at the center of a box may be used to infer whether all actions in a box are safe and there exists a future trajectory of only safe options.

In the embodiment depicted in FIG. 3, the potentially unsafe action (â) is determined to fall into an unsafe region of the action space (i.e., it is part of an unsafe set (u) from the partition (M)). The potentially unsafe action (â) is hence mapped into a safe set (k). The safe set (k) may be determined by selecting the partition element of the partition (M) that is closest to the potentially unsafe action (â) in terms of a distance measure on the action space, e.g., an Lₚ-norm. Alternatively, it is also possible to determine a density for actions acting as representatives for respective partition element, e.g., action at the center of the respective boxes. For example, for each partition element that is determined as safe a density of a respective action at the center may be determined based on the density determined from the policy module (61) and the partition element with highest density may be chosen as safe set (k).

In the embodiment, mapping the potentially unsafe action (â) to the safe action (ā) is then achieved by determining a relative position of the potentially unsafe action (â) in the unsafe set (u) along the horizontal and vertical axes and providing the action from the safe set (k) as safe action (ā) that has a same relative position along the horizontal and vertical axes in the safe set (k).

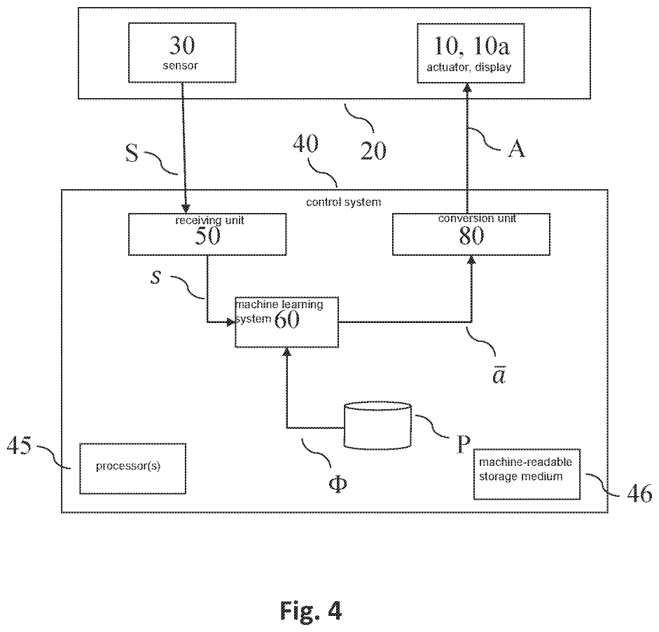

FIG. 4 shows a control system (40) comprising the machine learning system (60) for determining a control signal (A) for controlling an actuator (10) of a technical system in its environment (20). The actuator (10) interacts with the control system (40). The actuator (10) and its environment (20) will be jointly called actuator system. At preferably evenly spaced points in time, a sensor (30) senses a condition of the actuator system. The sensor (30) may comprise several sensors. Preferably, the sensor (30) is an optical sensor that takes images of the environment (20). An output signal (S) of the sensor (30) (or in case the sensor (30) comprises a plurality of sensors, an output signal (S) for each of the sensors) which encodes the sensed condition is transmitted to the control system (40).

Thereby, the control system (40) receives a stream of sensor signals (S). It then computes a series of control signals (A) depending on the stream of sensor signals (S), which are then transmitted to the actuator (10).

The control system (40) receives the stream of sensor signals (S) of the sensor (30) in an optional receiving unit (50). The receiving unit (50) transforms the sensor signals (S) into state signals (s). Alternatively, in case of no receiving unit (50), each sensor signal (S) may directly be taken as a state signal (s).

The state signal (s) is then passed on to a machine learning system (60).

The machine learning system (60) is parametrized by parameters (Φ), which are stored in and provided by a parameter storage (St₁).

The machine learning system (60) determines a safe action (ā) from the sate signal (s). The safe action (ā) is transmitted to an optional conversion unit (80), which converts the safe action (ā) into the control signals (A). The control signals (A) are then transmitted to the actuator (10) for controlling the actuator (10) accordingly. Alternatively, the safe action (ā) may already characterize a control signal (A) and may be submitted to the actuator (10) directly.

The actuator (10) receives control signals (A), is controlled accordingly, and carries out the safe action (ā) corresponding to the control signal (A). The actuator (10) may comprise a control logic which transforms the control signal (A) into a further control signal, which is then used to control actuator (10).

In further embodiments, the control system (40) may comprise the sensor (30). In even further embodiments, the control system (40) alternatively or additionally may comprise an actuator (10).

In still further embodiments, it can be envisioned that the control system (40) controls a display (10a) instead of or in addition to the actuator (10).

Furthermore, the control system (40) may comprise at least one processor (45) and at least one machine-readable storage medium (46) on which instructions are stored which, if carried out, cause the control system (40) to carry out a method according to an aspect of the present invention.

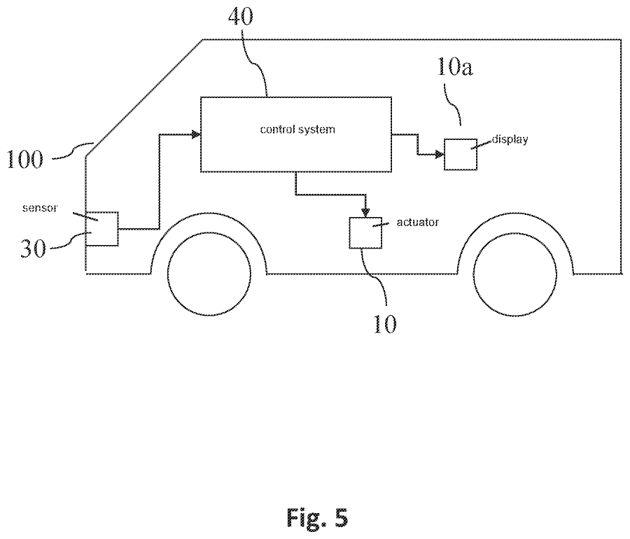

FIG. 5 shows an embodiment in which the control system (40) is used to control an at least partially autonomous robot, e.g., an at least partially autonomous vehicle (100).

The sensor (30) may comprise one or more video sensors and/or one or more radar sensors and/or one or more ultrasonic sensors and/or one or more LiDAR sensors. Some or all of these sensors are preferably but not necessarily integrated in the vehicle (100). The state signal (s) derived from the sensor signal (S) may characterize information about the environment of the vehicle, e.g. curvature of the road the vehicle (100) currently travels along and/or information about distance to other traffic participants and/or immobile environment entities such as trees, houses, or traffic cones and/or information about lanes or lane markings of the road. Alternatively, the sate signal (s) may characterize an image of the environment.

The machine learning system (60) may be configured to determine an action to be executed by the vehicle (100), e.g., a longitudinal and/or lateral acceleration. The action may be chosen by the machine learning system (60) such that the vehicle (100) follows a predefined path while not colliding with other elements of its environment, e.g., road participants. As a fail-safe action or fail-safe actions, the action determined by the machine learning system (60) may characterize an emergency brake and/or an emergency evasive steering and/or a lane switch into an emergency lane.

The actuator (10), which is preferably integrated in the vehicle (100), may be given by a brake, a propulsion system, an engine, a drivetrain, or a steering of the vehicle (100).

Alternatively or additionally, the control signal (A) may also be used to control the display (10a), e.g., for displaying the safe action (ā) determined by the machine learning system (60) and/or for displaying the partition of safe actions.

In further embodiments, the at least partially autonomous robot may be given by another mobile robot (not shown), which may, for example, move by flying, swimming, diving, or stepping. The mobile robot may, inter alia, be an at least partially autonomous lawn mower, or an at least partially autonomous cleaning robot. In all of the above embodiments, the control signal (A) may be determined such that propulsion unit and/or steering and/or brake of the mobile robot are controlled such that the mobile robot may avoid collisions with said identified objects.

In a further embodiment, the at least partially autonomous robot may be given by a gardening robot (not shown), which uses the sensor (30), preferably an optical sensor, to determine a state of plants in the environment (20). The actuator (10) may control a nozzle for spraying liquids and/or a cutting device, e.g., a blade. Depending on an identified species and/or an identified state of the plants, a control signal (A) may be determined to cause the actuator (10) to spray the plants with a suitable quantity of suitable liquids and/or cut the plants. In the embodiment, the safe action (a) may characterize a desired nozzle opening.

In even further embodiments, the at least partially autonomous robot may be given by a domestic appliance (not shown), like e.g. a washing machine, a stove, an oven, a microwave, or a dishwasher. The sensor (30), e.g., an optical sensor, may detect a state of an object which is to undergo processing by the household appliance. For example, in the case of the domestic appliance being a washing machine, the sensor (30) may detect a state of the laundry inside the washing machine. The control signal (A) may then be determined depending on a detected material of the laundry.

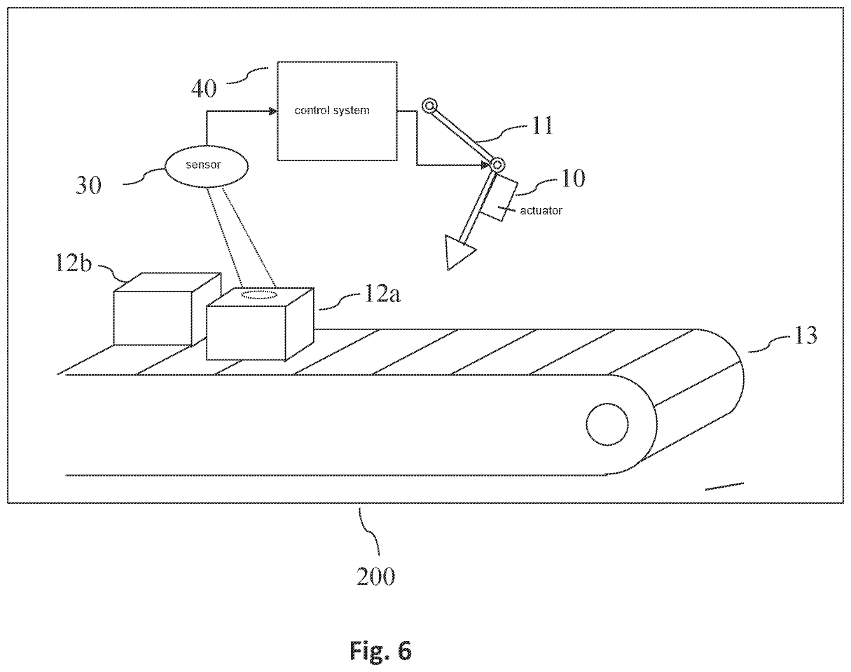

FIG. 6 shows an embodiment in which the control system (40) is used to control a manufacturing machine (11), e.g., a punch cutter, a cutter, a gun drill or a gripper, of a manufacturing system (200), e.g., as part of a production line. The manufacturing machine may comprise a transportation device, e.g., a conveyer belt or an assembly line, which moves a manufactured product (12). The control system (40) controls an actuator (10), which in turn controls the manufacturing machine (11).

The sensor (30) may be given by an optical sensor which captures properties of, e.g., a manufactured product (12).

The image machine learning system (60) may determine a position of the manufactured product (12) with respect to the transportation device. The actuator (10) may then be controlled depending on the determined position of the manufactured product (12) for a subsequent manufacturing step of the manufactured product (12). For example, the actuator (10) may be controlled to cut the manufactured product at a specific location of the manufactured product itself. Alternatively, it may be envisioned that the image machine learning system (60) classifies, whether the manufactured product is broken or exhibits a defect. The actuator (10) may then be controlled as to remove the manufactured product from the transportation device.

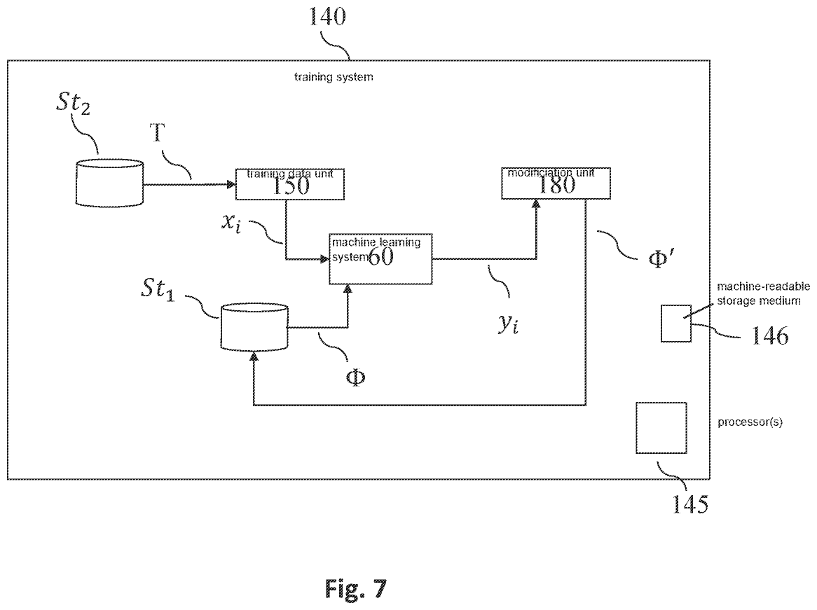

FIG. 7 shows an embodiment of a training system (140) for training the machine learning system (60) of the control system (40) by means of a training data set (T). The training data set (T) comprises a plurality of states signals (xᵢ) which are used for training the machine learning system (60).

For training, a training data unit (150) accesses a computer-implemented database (St₂), the database (St₂) providing the training data set (T). The training data unit (150) determines from the training data set (T) preferably randomly at least one state signal (xᵢ) and transmits the state signal (xᵢ) to the machine learning system (60). The machine learning system (60) determines a safe action (yᵢ) based on the state signal (xᵢ). The determined safe action (yᵢ) is transmitted to a modification unit (180).

Based on the determined safe action (yᵢ), the modification unit (180) then determines new parameters (Φ′) for the machine learning system (60). This may be achieved according to conventional reinforcement learning methods such as vanilla policy gradients, trust region policy optimization, proximal policy optimization, deep deterministic policy gradients, or actor-critic methods. Preferably, the new parameters may be determined according to the method of generative adversarial imitation learning.

The modification unit (180) determines the new parameters (Φ′) based on a loss value. In the given embodiment, this is done using a gradient ascent method, preferably stochastic gradient descent, Adam, or AdamW. In further embodiments, training may also be based on an evolutionary algorithm or a second-order method for training neural networks.

In other preferred embodiments, the described training is repeated iteratively for a predefined number of iteration steps or repeated iteratively until the loss value falls below a predefined threshold value. Alternatively or additionally, it is also possible that training is terminated when an average loss value with respect to a test or validation data set falls below a predefined threshold value. In at least one of the iterations the new parameters (Φ′) determined in a previous iteration are used as parameters (Φ) of the machine learning system (60) for a further iteration.

Furthermore, the training system (140) may comprise at least one processor (145) and at least one machine-readable storage medium (146) containing instructions which, when executed by the processor (145), cause the training system (140) to execute a training method according to one of the aspects of the present invention.

The term “computer” may be understood as covering any devices for the processing of pre-defined calculation rules. These calculation rules can be in the form of software, hardware or a mixture of software and hardware.

In general, a plurality can be understood to be indexed, that is, each element of the plurality is assigned a unique index, preferably by assigning consecutive integers to the elements contained in the plurality. Preferably, if a plurality comprises N elements, wherein N is the number of elements in the plurality, the elements are assigned the integers from 1 to N. It may also be understood that elements of the plurality can be accessed by their index.

What is claimed is:

1. A computer-implemented method for training a machine learning system, wherein the machine learning system is configured to determine a control signal characterizing an action to be executed by a technical system, wherein the method for training comprises the following steps:
obtaining a safe action to be executed by the technical system, including:
obtaining a state signal, wherein the state signal characterizes a state of an environment;
determining, by a parametrized policy module of the machine learning system, a distribution of potentially unsafe actions that could be executed by the technical system, wherein the policy module determines the distribution based on the obtained state signal;
sampling a potentially unsafe action from the distribution;
obtaining, by a safety module of the machine learning system, the safe action, wherein the safe action is obtained based on the sampled potentially unsafe action and a set of safe actions with respect to a current environment of the technical system;
determining a loss value based on the state signal and the safe action, wherein the loss value characterizes a reward obtained based on the safe action;
training the machine learning system by updating parameters of the policy module according to a gradient of the loss value with respect to the parameters.

2. The method according to claim 1, wherein the obtaining of the safe action by the safety module includes mapping the potentially unsafe action to an action from the set of safe actions when the potentially unsafe action is not in the set of safe actions, wherein the mapping is performed using a piecewise diffeomorphism.

3. The method according to claim 2, wherein the mapping of the potentially unsafe action to an action from the set of safe actions includes:
determining a countable partition of the space of actions;
determining, for each set of the countable partition, whether the set is safe set or an unsafe set, wherein a set is determined as safe set when the set includes only actions from the set of safe actions and when there exists a trajectory of actions for future states that includes only safe actions and wherein a set is determined as unsafe set otherwise;
when the potentially unsafe action is in an unsafe set:
determining a safe set from the partition based on the distribution of the potentially unsafe actions;
mapping the potentially unsafe action to an action from the safe set;
providing the action as the safe action;
Otherwise, when the potentially unsafe action is not in an unsafe set, providing the potentially unsafe action as the safe action.

4. The method according to claim 3, wherein the determining the safe set includes determining, for each safe set in the partition, a probability density of a representative action of the safe set of the partition with respect to the distribution of potentially unsafe actions, wherein the safe set including the representative action with a highest probability density value is provided as determined safe set.

5. The method according to claim 3, wherein the determining of the safe set includes determining, for each safe set in the partition, a probability density of a representative action of the safe set of the partition with respect to the distribution of potentially unsafe actions, wherein the safe set is sampled based on the determined probability densities and the sampled safe set is provided as determined safe set.

6. The method according to claim 3, wherein the safe set is determined by choosing the set from the partition that is deemed safe and has a minimal distance to the potentially unsafe action.

7. The method according to claim 3, wherein the mapping of the potentially unsafe action to an action from the safe set and the providing of the action as the safe action includes determining a relative position of the potentially unsafe action in the unsafe set and providing the action at the relative position in the safe set as the safe action.

8. The method according to claim 3, wherein the mapping of the potentially unsafe action to an action from the safe set and the providing of the action as the safe action includes determining an action from the safe set that has a minimal distance to the potentially unsafe action and providing the action as the safe action.

9. The method according to claim 1, wherein the loss value is determined by a discriminator, and training the machine learning system includes training the policy module and the discriminator according to generative adversarial imitation learning.

10. A computer-implemented method for determining a control signal for controlling an actuator of a technical system the method comprising the following steps:
training a machine learning system, wherein the machine learning system is configured to determine a control signal characterizing an action to be executed by a technical system, wherein the training includes:
obtaining a safe action to be executed by the technical system, including:
obtaining a state signal, wherein the state signal characterizes a state of an environment,
determining, by a parametrized policy module of the machine learning system, a distribution of potentially unsafe actions that could be executed by the technical system, wherein the policy module determines the distribution based on the obtained state signal,
sampling a potentially unsafe action from the distribution,
obtaining, by a safety module of the machine learning system, the safe action, wherein the safe action is obtained based on the sampled potentially unsafe action and a set of safe actions with respect to a current environment of the technical system,
determining a loss value based on the state signal and the safe action, wherein the loss value characterizes a reward obtained based on the safe action,
training the machine learning system by updating parameters of the policy module according to a gradient of the loss value with respect to the parameters; and
determining the control signal using the trained machined learning system and based on a state signal of an environment.

11. A machine learning system configured to determine a control signal characterizing an action to be executed by a technical system, wherein the machine learning system is trained by:
obtaining a safe action to be executed by the technical system, including:
obtaining a state signal, wherein the state signal characterizes a state of an environment;
determining, by a parametrized policy module of the machine learning system, a distribution of potentially unsafe actions that could be executed by the technical system, wherein the policy module determines the distribution based on the obtained state signal;
sampling a potentially unsafe action from the distribution;
obtaining, by a safety module of the machine learning system, the safe action, wherein the safe action is obtained based on the sampled potentially unsafe action and a set of safe actions with respect to a current environment of the technical system;
determining a loss value based on the state signal and the safe action, wherein the loss value characterizes a reward obtained based on the safe action;
training the machine learning system by updating parameters of the policy module according to a gradient of the loss value with respect to the parameters.

12. The method according to claim 1, wherein the policy module is trained according to a reinforcement learning paradigm or an imitation learning paradigm, wherein during inference of the machine learning system, potentially unsafe actions provided by the policy module are mapped to safe actions, by the safety module of the machine learning system, to safe actions.

13. A training system configured to train a machine learning system, wherein the machine learning system is configured to determine a control signal characterizing an action to be executed by a technical system, the training system configured to:
obtain a safe action to be executed by the technical system, including:
obtaining a state signal, wherein the state signal characterizes a state of an environment;
determining, by a parametrized policy module of the machine learning system, a distribution of potentially unsafe actions that could be executed by the technical system, wherein the policy module determines the distribution based on the obtained state signal;
sampling a potentially unsafe action from the distribution;
obtaining, by a safety module of the machine learning system, the safe action, wherein the safe action is obtained based on the sampled potentially unsafe action and a set of safe actions with respect to a current environment of the technical system;
determine a loss value based on the state signal and the safe action, wherein the loss value characterizes a reward obtained based on the safe action;
train the machine learning system by updating parameters of the policy module according to a gradient of the loss value with respect to the parameters.

14. A non-transitory machine-readable storage medium on which is stored a computer program for training a machine learning system, wherein the machine learning system is configured to determine a control signal characterizing an action to be executed by a technical system, the computer program, when executed by a processor, causing the processor to perform the following steps:
obtaining a safe action to be executed by the technical system, including:
obtaining a state signal, wherein the state signal characterizes a state of an environment;
determining, by a parametrized policy module of the machine learning system, a distribution of potentially unsafe actions that could be executed by the technical system, wherein the policy module determines the distribution based on the obtained state signal;
sampling a potentially unsafe action from the distribution;
obtaining, by a safety module of the machine learning system, the safe action, wherein the safe action is obtained based on the sampled potentially unsafe action and a set of safe actions with respect to a current environment of the technical system;
determining a loss value based on the state signal and the safe action, wherein the loss value characterizes a reward obtained based on the safe action;
training the machine learning system by updating parameters of the policy module according to a gradient of the loss value with respect to the parameters.
